(19) United States
(12) Patent Application Publication
(10) Pub. No.: US 2026/0288072 A1
(43) Pub. Date: Sep. 24, 2026

(54) CASE AND TIMEPIECE

(71) Applicant: CASIO COMPUTER CO., LTD., Tokyo (JP)

(72) Inventor: Yuya ARIMORI, Tokyo (JP)

(21) Appl. No.: 19/574,751

(22) Filed: Mar. 23, 2026

(30) Foreign Application Priority Data
Mar. 24, 2025 (JP) 2025-048407

(51) Int. Cl. G04B 37/00; G04B 37/22

(52) U.S. Cl. CPC G04B 37/0091; G04B 37/22

(57) ABSTRACT

A case includes: a case body; and an exterior member detachably attached to the case body. The case body has a notched portion formed partially in a portion that, when the exterior member is attached to the case body, faces an inner peripheral surface of the exterior member, and the exterior member has a first inclined portion provided in a portion that, when the exterior member is attached to the case body, faces the notched portion.

### CROSS-REFERENCE TO RELATED APPLICATION

This application is based upon and claims the benefit of priority from the prior Japanese Patent Application No. 2025-048407, filed on Mar. 24, 2025, the entire contents of which are incorporated herein by reference.

### BACKGROUND OF THE INVENTION

### TECHNICAL FIELD

The present invention relates to a case and a timepiece.

### Description of Related Art

Conventionally, cases are known that are constructed by attaching an exterior member to a case body. If the exterior member can be attached and detached by a user or the like, it becomes possible to enjoy the timepiece in various designs by exchanging the exterior member. In this regard, for example, JP 2022-029581A discloses a timepiece in which a jig can be inserted into a groove provided in an exterior member to remove the exterior member.

### SUMMARY OF THE INVENTION

A case reflecting one aspect of the present invention comprises: a case body; and an exterior member detachably attached to the case body, wherein the case body has a notched portion formed partially in a portion that, when the exterior member is attached to the case body, faces an inner peripheral surface of the exterior member, and the exterior member has a first inclined portion provided in a portion that, when the exterior member is attached to the case body, faces the notched portion.

### BRIEF DESCRIPTION OF DRAWINGS

The accompanying drawings are not intended as a definition of the limits of the invention but illustrate embodiments of the invention, and, together with the general description given above and the detailed description of the embodiments given below, serve to explain the principles of the invention, wherein:

FIG. 1 is a front view of a timepiece according to an embodiment;

FIG. 2 is a rear view of the timepiece according to the embodiment;

FIG. 3 is a perspective view illustrating the 3 o'clock side of a case body according to the embodiment;

FIG. 4 is a perspective view illustrating the 9 o'clock side of the case body according to the embodiment;

FIG. 5 is an enlarged view of a major portion of the side surface of a case according to the embodiment on the 9 o'clock side;

FIG. 6 is an enlarged perspective view of a major portion on the 9 o'clock side of the case according to the embodiment;

FIG. 7 is an enlarged cross-sectional view of a major portion on the 9 o'clock side of the case taken along line VII-VII in FIG. 1;

FIG. 8 is a schematic explanatory diagram illustrating chamfer angles of a first inclined portion and a second inclined portion;

FIG. 9 is an enlarged perspective view of a locking portion of the case body according to the embodiment;

FIG. 10 is a cross-sectional view of a major portion of the case taken along line X-X in FIG. 1;

FIG. 11 is a cross-sectional view of a major portion on the 9 o'clock side of the timepiece illustrated in FIG. 1, illustrating insertion of a fingertip between the case and an exterior member;

FIG. 12 is an explanatory diagram illustrating release of locking of the locking portion illustrated in FIG. 10 when the fingertip is hooked at the location shown in FIG. 11 and pulled in the direction of the arrow; and

FIG. 13 is an explanatory diagram illustrating release of locking between the case body and the exterior member according to the embodiment from the 9 o'clock side of the timepiece.

### DETAILED DESCRIPTION

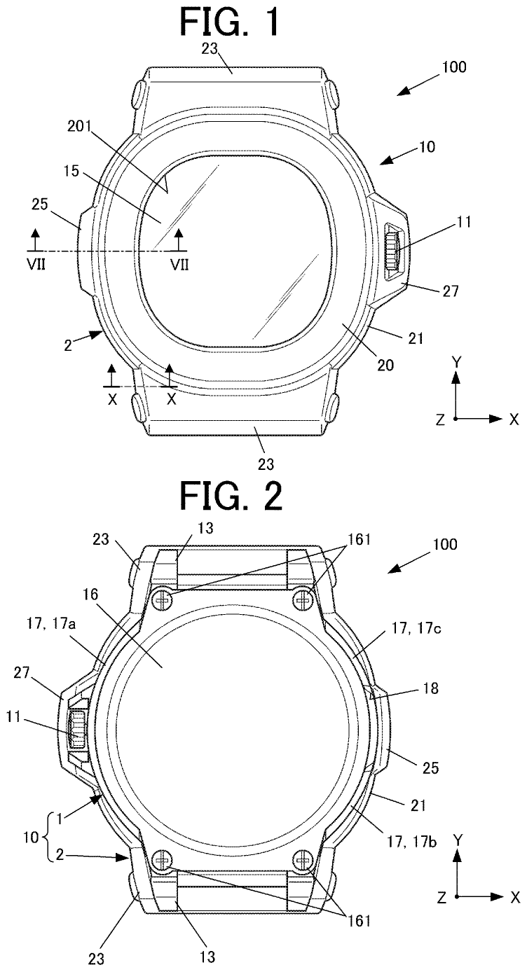

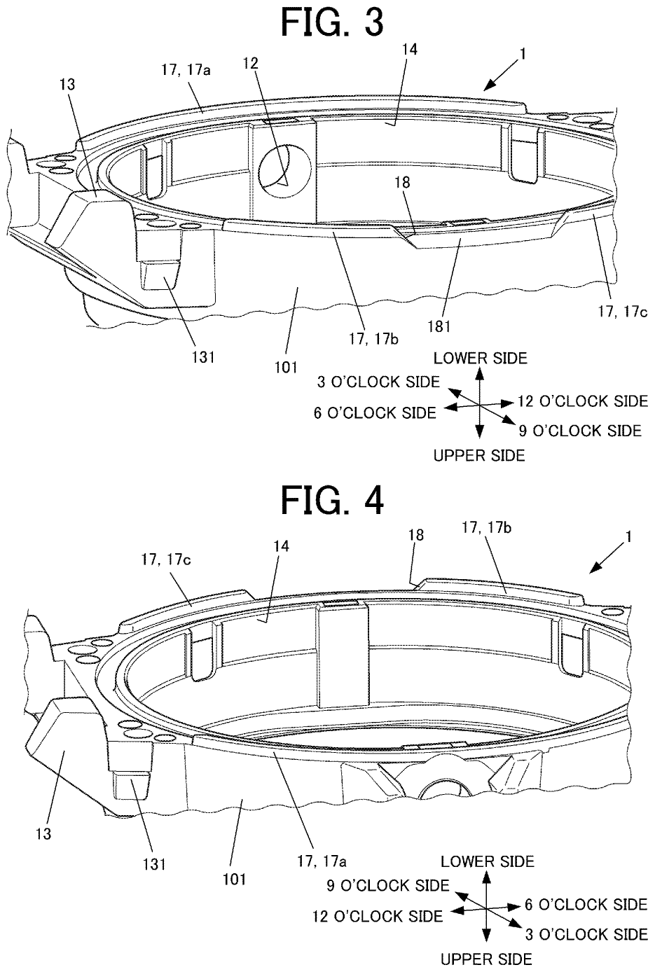

With reference to FIGS. 1 to 13, an embodiment of a case and a timepiece according to the present invention will be described. The embodiment described below is illustrated using a wristwatch (hereinafter referred to as “timepiece 100”) worn on the wrist as an example. Furthermore, in the following description, the X-, Y-, and Z-directions in the timepiece 100 refer to the orientations shown in FIG. 1. Specifically, the X-direction refers to the 3 o'clock to 9 o'clock direction in an analog timepiece (the 3 o'clock to 9 o'clock direction shown in FIGS. 3 and 4). The Y-direction refers to the 12 o'clock to 6 o'clock direction (the 12 o'clock to 6 o'clock direction shown in FIGS. 3 and 4). Furthermore, the Z-direction is the thickness direction (up-down direction) of the timepiece 100 and is a first direction of a case 10 in the embodiment. In the Z-direction, the front side, which is the visible side, is referred to as the “upper side (upward)”, which is called the “other side” in the embodiment; and the back side is referred to as the “lower side (downward)”, which is called the “one side” in the embodiment. Furthermore, the direction perpendicular to the central axis (not shown) of the case 10 along the Z-direction is referred to as the “radial direction”, and the direction of rotation about the central axis is referred to as the “circumferential direction”. Within the plane perpendicular to the central axis, the side closer to the central axis is referred to as the “inner side (inner diameter side)”, and the side farther from the central axis is referred to as the “outer side (outer diameter side).” The following embodiment is provided with various limitations technically preferable for carrying out the present invention. However, the scope of the present invention is not limited to the following embodiment or illustrated examples.

As illustrated in FIG. 2 and other figures, the timepiece 100 according to the present embodiment includes the case 10. The case 10 includes a case body 1 and an exterior member 2. In the embodiment, the case body 1 is formed of, for example, a super engineering plastic such as polyarylate (PAR), an engineering plastic such as polyacetal (POM), or a rigid synthetic resin such as glass fiber reinforced resin. The material forming the case body 1 is not particularly limited. The case body 1 needs only to be formed of a material of a certain degree of rigidity and may be formed of materials other than those illustrated. For example, the case body 1 may be formed of various metallic materials such as stainless steel (SUS) or titanium.

The case body 1 is cylindrical and extends along the Z-direction (first direction), which is the thickness direction of the timepiece 100. The case body 1 has a hollow short-column shape with openings at the top and bottom in the Z-direction. The cylindrical portion of the case body 1 is referred to as a peripheral wall 101. An operating element 11, such as a crown or a push button, is provided on the outer periphery of the case body 1 (peripheral wall 101) for a user to perform various input operations. For example, the operating element 11 is provided on the outer side of the peripheral wall 101, on the 3 o'clock or 9 o'clock side of an analog timepiece. In the example illustrated in FIG. 1, a crown is provided as the operating element 11 on the 3 o'clock side of an analog timepiece. A through hole 12 (see FIG. 3) is formed in the peripheral wall 101 at a position corresponding to the shaft portion (so-called winding stem) of the crown. The through hole 12 penetrates the case body 1.

Furthermore, in the embodiment, band attachment portions 13 are provided on the outer side of the case body 1, on opposite sides in the Y-direction (12 o'clock to 6 o'clock direction). The band attachment portions 13 are provided to connect a band (not shown) to the case body 1. As illustrated in FIGS. 3, 4 and 9, the band attachment portions 13 of the embodiment have locking portions 131 formed on their sides. The locking portions 131 are to lock the exterior member 2. In the embodiment, the locking portions 131 are provided, for example, as shown in FIGS. 3 and 4, at two locations in each band attachment portion 13, totaling four locations in the entire case body 1. One of the locking portions 131 is provided on a surface of the band attachment portion 13 on the 3 o'clock side in the X-direction, and another on a surface on the 9 o'clock side. Each of the locking portions 131 is a hook-shaped claw protruding outward. The locking portions 131 need only to be capable of locking the exterior member 2, and their specific shape is not limited to the illustrated example.

A watch glass 15 (see FIG. 1) is attached to the upper side of the case body 1 (the upper side in the Z-direction, the visible side of the timepiece, the front surface side) to close off notched portions on the upper side. The watch glass 15 is a transparent member (cover member) formed, for example, of glass material or transparent resin material. Furthermore, a back cover 16 is attached to the lower side of the case body 1 (the lower side in the Z-direction, the back surface side of the timepiece 100) using screws 161. Notched portions 14 on the lower side of the case body 1 (see FIGS. 3 and 4) are closed off with the back cover 16. It is preferable that the watch glass 15 and the back cover 16 are attached via a waterproof ring or the like. By interposing a waterproof ring or the like between the watch glass 15 or the back cover 16 and the case body 1, the upper and lower openings of the case body 1 are sealed in an airtight state.

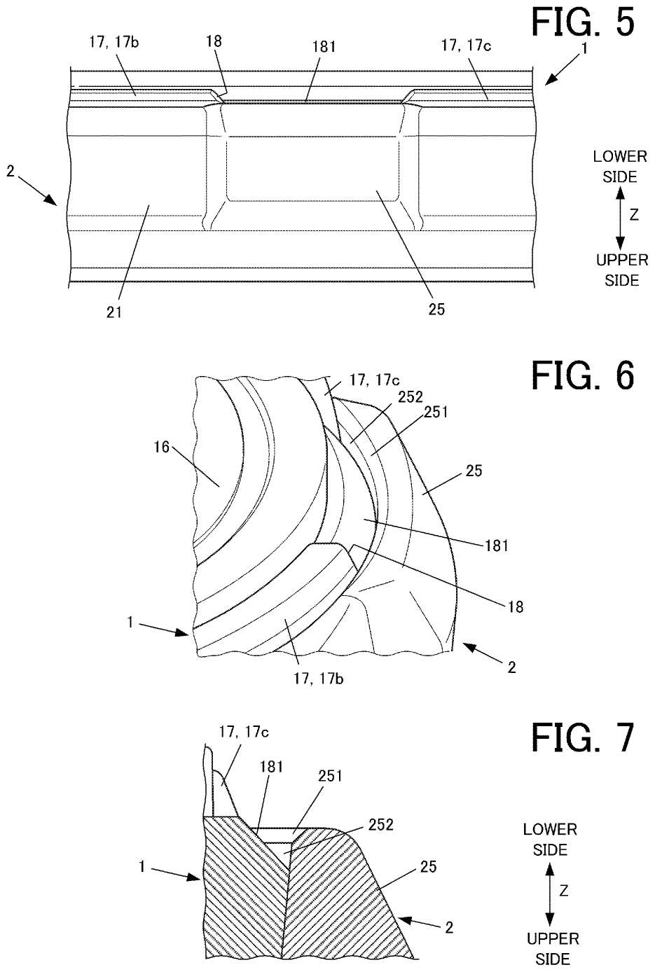

In the embodiment, the case body 1 has extension portions 17 that extend toward one end in the first direction (the one side, the lower side in the Z-direction) and are provided along the outer periphery. The extension portions 17 function as a back cover guide that positions the back cover 16, which is provided on the one side in the first direction (the lower side in the Z-direction) of the case body 1. The height of the extension portions 17 is not particularly limited, provided that it allows for positioning of the back cover 16. In the embodiment, as illustrated in FIGS. 3 and 4, a single continuous extension portion 17 (17a) is provided on the 3 o'clock side of an analog timepiece, and an extension portion 17b (closer to the 6 o'clock side) and an extension portion 17c (closer to the 12 o'clock side) are provided on the 9 o'clock side. Between the extension portion 17b and the extension portion 17c is a notched portion 18, and the extension portion 17 on the 9 o'clock side is divided into two portions by the notched portion 18. When the exterior member 2 described later is attached to the case body 1, the extension portions 17 of the case body 1 face the inner peripheral surface of the exterior member 2. In the embodiment, the notched portion 18 is formed in a portion of these extension portions 17, which face the inner peripheral surface of the exterior member 2. Furthermore, a chamfered portion 181 (second inclined portion) is formed in this notched portion (notched portion 18) (see FIG. 5).

The exterior member 2 is provided on the outer side of the case body 1. In the embodiment, the exterior member 2 is implemented as a bezel detachably attached to the case body 1 from the other end (the other side, the upper side in the embodiment) in the first direction (Z-direction). The thickness direction (height direction) of the exterior member 2 coincides with the first direction (Z-direction) of the case body 1. The exterior member 2 is formed of a synthetic resin such as a urethane resin like polyurethane (PUR). The material forming the exterior member 2 is not limited to urethane resin. However, it is preferable that the material possesses overall flexibility, and a soft thermoplastic resin is preferred. The exterior member 2 is provided to cover at least the upper side and the side surface of the case body 1. The exterior member 2 of the embodiment has a top surface portion 20, a side surface portion 21, and covering portions 23. The top surface portion 20 is positioned on the front surface side (the other side in the Z-direction) of the case body 1 when the exterior member 2 is attached to the case body 1. The top surface portion 20 is a frame-like structure with a notched portion 201 formed in its central region in the in-plane direction. The watch glass 15 mounted on the case body 1 is exposed through the notched portion 201. Furthermore, the side surface portion 21 extends downward in the Z-direction from the top surface portion 20. The side surface portion 21 is positioned on the side of the case body 1 such that the side surface portion 21 covers the peripheral wall 101 when the exterior member 2 is attached to the case body 1. The covering portions 23 cover the band attachment portions 13 of the case body 1 when the exterior member 2 is attached to the case body 1. The covering portions 23 are provided in the exterior member 2 at positions corresponding to the 12 o'clock and 6 o'clock sides of the timepiece.

The exterior member 2 (the side surface portion 21 of the exterior member 2 in the embodiment) has a chamfered portion 251 (first inclined portion) formed in a portion facing the notched portion 18 formed in the case body 1. In the embodiment, the notched portion 18 is formed in the case body 1 on the 9 o'clock side of the timepiece. The chamfered portion 251 (first inclined portion) is provided in the side surface portion 21 of the exterior member 2 on the 9 o'clock side of the timepiece, corresponding to the notched portion 18. The portion where the chamfered portion 251 (first inclined portion) is provided may have a greater radial thickness than other portions of the side surface portion 21. In the embodiment, as illustrated in FIG. 1 and other figures, a bulging portion 25 that bulges outward is formed on the 9 o'clock side of the side surface portion 21. Applying chamfering to the side surface portion 21 reduces the wall thickness of the side surface portion 21 of the exterior member 2 by that amount. However, by making the portion where the chamfered portion 251 is provided thicker than elsewhere, it is possible to prevent the wall from becoming excessively thin. Furthermore, the location where the chamfered portion 251 is provided is where a fingertip F or similar object is hooked onto when removing the exterior member 2 from the case body 1. Therefore, it is also preferable to provide the bulging portion 25 to clearly indicate to the user where the hooking point for the fingertip F or similar object is located. Note that providing the bulging portion 25 is not essential, and the radial thickness at the location where the chamfered portion 251 is provided may be the same as that of the other portions.

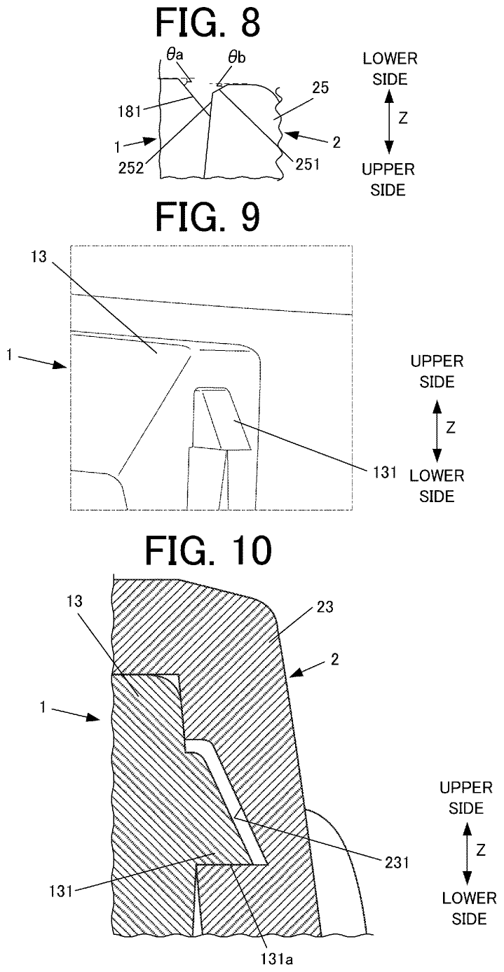

As illustrated in FIGS. 6 to 8, the chamfered portion 251 (first inclined portion) provided in the exterior member 2 and the chamfered portion 181 (second inclined portion) provided in the case body 1 face each other when the exterior member 2 is attached to the case body 1. However, the chamfer angle (designated as “angle θa” in FIG. 8) of the chamfered portion 181 (second inclined portion) of the case body 1 is larger than the chamfer angle (designated as “angle θb” in FIG. 8) of the chamfered portion 251 (first inclined portion) of the exterior member 2. This ensures sufficient space to insert the fingertip F or similar object. The specific values for the chamfer angles of the chamfered portion 181 (second inclined portion) and the chamfered portion 251 (first inclined portion), as well as the degree of difference between these chamfer angles, are matters to be set appropriately.

Furthermore, the chamfered portion 251 (first inclined portion) is provided on the one side in the first direction (the lower side in the Z-direction) of the exterior member 2. In a cross-sectional view taken at the location where the chamfered portion 251 is provided, the portion that is provided on the other side in the first direction (the upper side in the Z-direction) of the chamfered portion 251 and faces the chamfered portion 181 (second inclined portion) of the case body 1 is a straight portion (straight portion 252) that has not undergone chamfering. The portion where the fingertip F or similar object is hooked onto when removing the exterior member 2 from the case body 1 is near the end of the exterior member 2 on the one side in the first direction (the lower side in the Z-direction). Thus, it is unlikely to deeply insert the fingertip F or similar object all the way to the other side in the first direction (the upper side in the Z-direction). On the other hand, if chamfering is applied deeply, all the way to the other side in the first direction (the upper side in the Z-direction), to form an inclined surface, the thickness at the location where the chamfered portion 251 is provided becomes thinner, thereby reducing the strength of the exterior member 2. In particular, the location where the chamfered portion 251 is provided is a point subjected to load each time the exterior member 2 is attached or detached, making it preferable to ensure strength as much as possible. In this regard, as in the embodiment, chamfering is applied only near the end on the one side in the first direction (the lower side in the Z-direction), while chamfering is not applied to the portion that is deeper than this chamfered end portion on the other side in the first direction (the upper side in the Z-direction). This preserves the thickness of the exterior member 2 and maintains its strength.

Furthermore, in the embodiment, a protrusion portion 27 is formed at a position substantially point-symmetrical with respect to the center of the exterior member 2 in plan view to the position where the chamfered portion 251 (first inclined portion) is provided in the exterior member 2 (the 9 o'clock position of the timepiece in the embodiment). The protrusion portion 27 protrudes outward from the side surface portion 21 and is provided on the 3 o'clock side of an analog timepiece. The shape of the protrusion portion 27 is not particularly limited. However, in the embodiment, the crown, which is the operating element 11, is provided on the 3 o'clock side of the timepiece. In the embodiment, the protrusion portion 27 serves as a crown guard protecting the operating head of this crown. Note that the protrusion portion 27 is not limited to being a crown guard. Even when the timepiece 100 does not include a crown, a protrusion portion may be provided for decorative purposes or similar reasons.

As described above, in the embodiment, the location where the chamfered portion 251 (first inclined portion) is provided is the portion where the fingertip F or similar object is hooked onto when the exterior member 2 is attached to or detached from the case body 1 and where force pulling the exterior member 2 outward from the timepiece 100 is applied. In this regard, the presence of the protrusion portion 27 on the 3 o'clock side, which is a position substantially point-symmetrical to this location (the 9 o'clock position of the timepiece), allows the timepiece 100 to be supported by grasping the protrusion portion 27 on the 3 o'clock side when force is applied on the 9 o'clock side. Specifically, when the protrusion portion 27 is a crown guard as in the embodiment, its entire shape is substantially annular, encircling the crown head. Consequently, it is easy to grasp the protrusion portion 27 with the fingertip F or similar object, allowing for removal of the exterior member 2 while maintaining balance between the 3 o'clock and 9 o'clock sides.

Furthermore, each of the covering portions 23 covers substantially the entire band attachment portion 13 of the case body 1 when the exterior member 2 is attached to the case body 1. As described above, the hook-shaped locking portions 131 are provided on the surfaces of each band attachment portion 13 on the 3 o'clock side and the 9 o'clock side, protruding outward. On the inner surface of each covering portion 23 of the exterior member 2, recesses 231 are formed at positions corresponding to the respective locking portions 131. The locking portions 131 are locked to the respective recesses 231. The shape of the recesses 231 is not particularly limited. However, in the embodiment illustrated in FIG. 10 and other figures, the recesses 231 have a shape that follows the corresponding hook-shaped locking portions 131. Specifically, each of the recesses 231 in the embodiment has a shape that receives the lower-side surface 131a of the locking portion 131 in the Z-direction (see FIG. 10). This ensures that the exterior member 2, which is locked to the case body 1 from the lower side in the Z-direction and fitted over the case body 1 from the upper side in the Z-direction, remains securely attached and does not easily detach after installation.

Next, the operation of the case 10 according to the present embodiment and the timepiece 100 including the case 10 will be described. When assembling the timepiece 100 according to the embodiment, the module 3 and the like are housed within the case body 1, and the operating element 11 such as a crown is attached as appropriate. Then, the notched portions on the upper side (upper side in the Z-direction, front surface side, visible side) of the case body 1 are closed off with the watch glass 15. The case body 1 is secured on the lower side (lower side in the Z-direction, back surface side, non-visible side) by fixing the back cover 16 with the screws 161, thereby closing off the notched portions 14 with the back cover 16. This completes the assembly of the case body 1.

When attaching the exterior member 2 to the case body 1, the exterior member 2 is fitted by placing the exterior member 2 over the case body 1 from the upper side (the upper side in the Z-direction). For example, the protrusion portion 27 (crown guard) is fitted from the 3 o'clock side of the timepiece where the crown (operating element 11) is located, placing the top surface portion 20 on the upper side (upper side in the Z-direction) of the case body 1. This causes the watch glass 15 to be exposed through the notched portion 201 of the top surface portion 20. Furthermore, the side surface portion 21 of the exterior member 2 is guided along the outer side of the peripheral wall 101 of the case body 1 such that the bulging portion 25 is positioned on the 9 o'clock side of the timepiece. Furthermore, the covering portions 23 are placed over the respective band attachment portions 13 of the case body 1. The locking portions 131 formed in each band attachment portion 13 are locked into the respective recesses 231 formed on the inner surface of the corresponding covering portion 23. Specifically, the lower-side surface 131a of the locking portion 131 in the Z-direction contacts and hooks onto the lower-side surface of the recess 231 like a hook, thereby preventing the exterior member 2 from easily detaching from the case body 1. In this state, the bulging portion 25 of the exterior member 2 is positioned on the 9 o'clock side of the timepiece where the notched portion 18 of the case body 1 is provided. The chamfered portion 251 (first inclined portion) faces the notched portion 18 (the chamfered portion 181 (second inclined portion) provided in the notched portion 18). This completes the case 10 with the exterior member 2 attached to the case body 1.

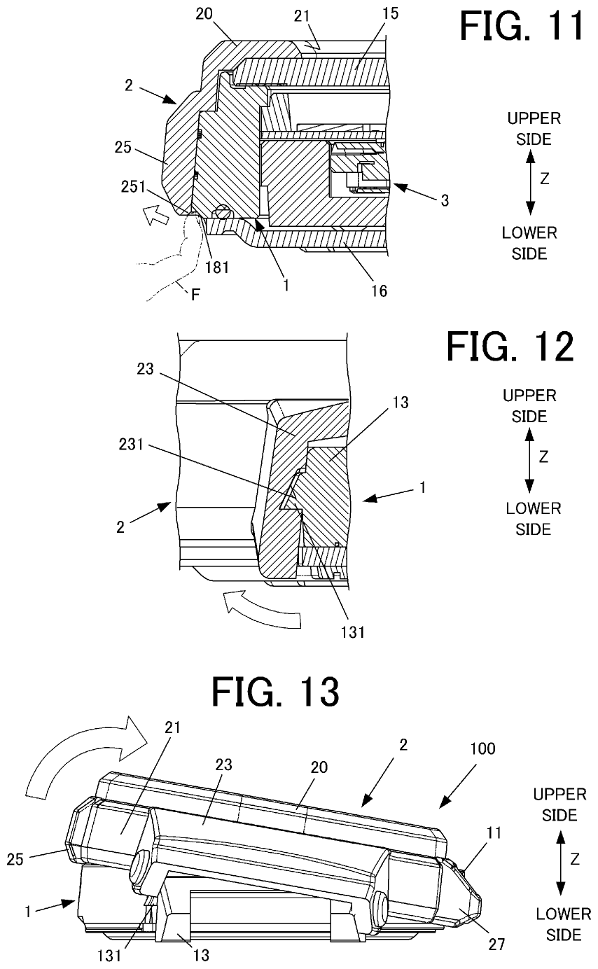

When removing the exterior member 2 from the case body 1, as illustrated in FIG. 11, the user inserts the fingertip F or similar object into the portion where the chamfered portion 251 (first inclined portion) and the notched portion 18 (the chamfered portion 181 (second inclined portion) provided in the notched portion 18) face each other and peels off the exterior member 2 outward (in the direction of the white-filled arrow shown in FIG. 11). As illustrated in FIG. 7 and other figures, a substantially V-shaped gap is formed where the chamfered portion 251 (first inclined portion) and the chamfered portion 181 (second inclined portion) face each other. Consequently, the user can pull the exterior member 2 outward by inserting the fingertip F or similar object, without needing special jigs or tools.

In the embodiment, the location where the chamfered portion 251 (first inclined portion) and the chamfered portion 181 (second inclined portion) face each other is positioned on the 9 o'clock side of the timepiece. As the exterior member 2 is peeled away from the 9 o'clock side of the timepiece, the exterior member 2 is also peeled away from the case body 1 in the band attachment portions 13 provided on the 12 o'clock and 6 o'clock sides of the timepiece, as indicated by the white-filled arrow in FIG. 12. This causes the locking portion 131 on the surface of the band attachment portion 13 on the 9 o'clock side to be released from the corresponding recess 231 of the exterior member 2, thereby allowing the exterior member 2 to be removed from the case body 1 starting from the 9 o'clock side of the timepiece, as illustrated in FIG. 13. Then, for example, when the user pulls the protrusion portion 27 from the 3 o'clock side of the timepiece, the locking portion 131 on the surface of the band attachment portion 13 on the 3 o'clock side is also released from the corresponding recess 231 of the exterior member 2, allowing the entire exterior member 2 to be removed from the case body 1.

Thus, according to the present embodiment, when the case 10 of the timepiece 100 includes the case body 1 and the exterior member 2 that is detachably attached to the case body 1, the exterior member 2 can be peeled off and removed from the case body 1 simply by hooking the fingertip F or similar object onto the exterior member 2. This allows the exterior member 2 to be exchanged according to one's mood or preference without needing to carry special jigs. Consequently, exchanging the exterior member 2 with another of different color, shape, surface finish, or the like enables a wide variety of enjoyment with the single timepiece 100, such as changing the appearance according to the place where the timepiece 100 is worn.

Next, the effects of the case 10 according to the embodiment and the timepiece 100 including the case 10 will be described. For example, in conventional configurations such as those described in JP 2022-029581A, a jig is required to remove an exterior member, making it difficult to remove the exterior member. In this regard, the case 10 according to the embodiment includes: the cylindrical case body 1 that extends along the Z-direction (the first direction); and the exterior member 2 that is detachably attached to the case body 1 from the upper side (the other side, the front surface side, the visible side) in the Z-direction (the first direction). The case body 1 has the notched portion 18 formed partially in a portion that, when the exterior member 2 is attached to the case body 1, faces the inner peripheral surface of the exterior member 2. The exterior member 2 has the chamfered portion 251 (first inclined portion) in a portion that faces the notched portion 18. This creates a gap where the notched portion 18 of the case body 1 and the chamfered portion 251 (first inclined portion) of the exterior member 2 face each other. By hooking the fingertip F or similar object onto this gap, the user can easily attach or detach the exterior member 2 without using a jig or similar tool. Consequently, the exterior member 2 can be easily exchanged. This allows the user to enjoy design variations, even with just one case body 1, by attaching one of various exterior members 2 to the case body 1 according to his/her mood or the place where the timepiece 100 is worn.

Furthermore, in the embodiment, the case body 1 has the extension portions 17 that extend toward the lower side (the back surface side, non-visible side) in the Z-direction, which is the one side in the first direction, and are provided along the outer periphery, and the notched portion 18 is provided in these extension portions 17. If any portion extends above (toward the lower side in the Z-direction beyond) the peripheral wall 101, which is the side surface of the case body 1, that extension portion becomes an obstacle when attempting to hook the fingertip F or similar object onto the exterior member 2, making hooking difficult. In this regard, cutting out the portion that faces the chamfered portion 251 (first inclined portion), which is the hooking point for the fingertip F or similar object, of the exterior member 2 to eliminate that particular portion in the extension portions 17 makes it easier to hook the fingertip F or similar object when removing the exterior member 2 from the case body 1. Furthermore, providing the notched portion 18 allows the user to easily recognize where to hook the fingertip F or similar object to remove the exterior member 2 from the case body 1.

Furthermore, in the embodiment, the notched portion 18 of the case body 1 has the chamfered portion 181 (second inclined portion). The chamfered portion 251 (first inclined portion) is provided in the exterior member 2 at the location corresponding to the notched portion 18. By providing the chamfered portion 181 (second inclined portion) at the location corresponding to the chamfered portion 251, a substantially V-shaped gap can be formed between the chamfered portion 251 and the chamfered portion 181. Consequently, when hooking the fingertip F or similar object onto the chamfered portion 251 to pull the exterior member 2, the fingertip F or similar object can be hooked more easily.

Furthermore, in the embodiment, the chamfer angle (designated as “angle θa” in FIG. 8) of the chamfered portion 181 (second inclined portion) is formed to be larger than the chamfer angle (designated as “angle θb” in FIG. 8) of the chamfered portion 251 (first inclined portion). In the portion where the two chamfered portions (chamfered portion 251 and chamfered portion 181) face each other, if either chamfered portion has a sufficient chamfer angle, a gap can be secured for hooking the fingertip F or similar object. In this regard, the case body 1 is formed of a high-hardness material, and there is no particular need for high strength for the portion where the chamfered portion 181 is provided. However, the exterior member 2 is a component possessing a certain degree of flexibility, and the portion where the chamfered portion 251 is provided is also a portion subjected to repeated loading during attachment and removal. Therefore, in the case body 1, the chamfer angle of the chamfered portion 181 (second inclined portion) is made deeper (larger) so that, in the exterior member 2, which is formed of a material having lower rigidity than the case body 1, the thickness of the portion where the chamfered portion 251 is provided can be preserved as much as possible. This ensures the strength of the exterior member 2.

Furthermore, in the embodiment, the chamfered portion 251 (first inclined portion) is provided on the lower side (back surface side, non-visible side) in the Z-direction, which is the one side in the first direction, of the exterior member 2. In a cross-sectional view taken at the location where the chamfered portion 251 is provided, the portion that is provided on the upper side (front surface side, visible side) in the Z-direction, which is the other side in the first direction, of the chamfered portion 251 and faces the chamfered portion 181 (second inclined portion) of the case body 1 is a straight portion (the straight portion 252) that is not inclined in the radial direction. This ensures a sufficient gap between the chamfered portion 251 and the chamfered portion 181 for easy hooking of the fingertip F or similar object, while preserving the thickness of the portion where the chamfered portion 251 is provided as much as possible in the exterior member 2. This ensures the strength of the exterior member 2.

Furthermore, in the embodiment, the exterior member 2 has the protrusion portion 27 at a position substantially point-symmetrical to the chamfered portion 251 (first inclined portion). As a result, as illustrated in FIGS. 11 to 13, for example, when the exterior member 2 is peeled off from the case body 1 by hooking the fingertip F or similar object onto the chamfered portion 251 (first inclined portion) on the 9 o'clock side, after the locking portion 131 on the 9 o'clock side is released and the exterior member 2 is lifted from the 9 o'clock side, the locking portion 131 on the 3 o'clock side can also be easily released by pulling the protrusion portion 27 from the 3 o'clock side.

Furthermore, in the embodiment, in the exterior member 2 (the side surface portion 21 of the exterior member 2), the portion where the chamfered portion 251, which is the first inclined portion, is provided is the bulging portion 25 having a greater radial thickness than the other portions of the side surface portion 21. Applying chamfering to the side surface portion 21 reduces the wall thickness of the side surface portion 21 of the exterior member 2 by that amount. However, by making the portion where the chamfered portion 251 is provided thicker than elsewhere, it is possible to prevent the wall from becoming excessively thin. Furthermore, the location where the chamfered portion 251 is provided is where the fingertip F or similar object is hooked onto when removing the exterior member 2 from the case body 1. Providing the bulging portion 25 makes it easier for the user to identify where the fingertip F or similar object is to be hooked onto.

Furthermore, in the timepiece 100 that includes the case 10 according to the embodiment, the user can easily remove the exterior member 2 from the case body 1 to exchange the exterior member 2. Therefore, depending on the user's mood for the day, the place where the timepiece 100 is worn, the situation, or the like, the exterior member 2 can be exchanged, allowing the user to easily enjoy the timepiece 100 with various appearances.

Although an embodiment of the present invention is described above, the present invention is not limited to the embodiment and can be appropriately modified in a variety of aspects without departing from the scope of the present invention. For example, in the present embodiment, as illustrated in FIGS. 3 and 4, the case 10 is illustrated as being substantially circular in plan view, but the shape of the case 10 is not limited thereto. For example, the case 10 may be rectangular or the like. Furthermore, the shape of the timepiece 100 including the case 10 is not limited to the illustrated example and may be, for example, substantially circular in plan view or substantially elliptical in plan view.

Furthermore, for example, in the present embodiment, an example is illustrated where the chamfered portion 251 (first inclined portion), the corresponding notched portion 18, and the chamfered portion 181 (second inclined portion) provided in the notched portion 18 are provided on the 9 o'clock side of an analog timepiece. However, the positions where the chamfered portion 251, the notched portion 18, and the chamfered portion 181 are provided are not limited thereto. For example, the chamfered portion 251, the notched portion 18, and the chamfered portion 181 may be provided on the 6 o'clock side or the 12 o'clock side of an analog timepiece. Furthermore, when the timepiece 100 does not have the operating element 11 such as a crown on the 3 o'clock side, the chamfered portion 251, the notched portion 18, and the chamfered portion 181 may be provided on the 3 o'clock side of the timepiece. Furthermore, since the chamfered portion 251, the notched portion 18, and the chamfered portion 181 serve as the hooking point for the fingertip F or similar object when removing the exterior member 2 from the case body 1, it is preferable to position the chamfered portion 251, the notched portion 18, and the chamfered portion 181 at an easily identifiable location for the user, such as the 12 o'clock, 6 o'clock, 3 o'clock, or 9 o'clock side, rather than at an intermediate location such as the 2 o'clock or 5 o'clock side.

For example, when the chamfered portion 251, the notched portion 18, and the chamfered portion 181 are provided on the 3 o'clock side of the timepiece, it is preferable to provide a protrusion portion on the 9 o'clock side of the timepiece, which is a position substantially point-symmetrical to the chamfered portion 251 (first inclined portion) and the like in plan view. Furthermore, it is not essential to provide a protrusion portion at a position substantially point-symmetrical to the chamfered portion 251 (first inclined portion) and the like. For example, a protrusion portion may be omitted, or a protrusion portion may be provided at a position not substantially point-symmetrical to the chamfered portion 251 (first inclined portion) and the like. When a protrusion portion is provided, even if the protrusion portion is not at a position substantially point-symmetrical to the chamfered portion 251 (first inclined portion) and the like, it is preferable to provide the protrusion portion at a position facing the chamfered portion 251 (first inclined portion) and the like, as far apart as possible. For example, when the chamfered portion 251 (first inclined portion) and the like are provided at the 9 o'clock position of the timepiece as in the embodiment, it is preferable to provide a protrusion portion at a position opposite the chamfered portion 251 (first inclined portion) and the like, across the Y-direction line connecting 12 o'clock and 6 o'clock. In this case, for example, a protrusion portion may be provided at the 4 o'clock position or the 5 o'clock position of the timepiece. Furthermore, for example, when the chamfered portion 251 (first inclined portion) and the like are provided at the 12 o'clock position of the timepiece, it is preferable to provide a protrusion portion at a position opposite the chamfered portion 251 (first inclined portion) and the like, across the X-direction line connecting 3 o'clock and 9 o'clock. In this case, for example, a protrusion portion may be provided at the 6 o'clock position or the 5 o'clock position of the timepiece. By positioning a protrusion portion at such a position, when the exterior member 2 is peeled away from the side with the chamfered portion 251 (first inclined portion) and the like, the exterior member 2 can be easily pulled and removed from the opposite side.

Furthermore, in the above embodiment, the locking portion 131 provided in the case body 1 and the recess 231 that locks the locking portion 131 are exemplified as being provided respectively in the band attachment portion 13 and the covering portion 23 covering the band attachment portion 13. However, the locking portion 131 and the recess 231 need only to be capable of locking the exterior member 2 to the case body 1, and their specific arrangement, number provided, and the like are not limited to the described example. The locking portion 131 and the recess 231 may be provided at any location where the case body 1 and the exterior member 2 come into contact with each other. Furthermore, to lock the entire exterior member 2 to the case body 1 as evenly as possible, it is preferable to provide the locking portions 131 and recesses 231 at multiple positions that are as even as possible in the X-direction and Y-direction.

Furthermore, in the above embodiment, the first direction in the case body 1 is the Z-direction (thickness direction), and the example illustrates a case where the exterior member 2 is attached to or detached from the case body 1 on the upper side. However, the direction of attachment and detachment of the exterior member 2 need not necessarily be on the upper side in the Z-direction (thickness direction). For example, the direction of attachment and detachment of the exterior member 2 may be in a diagonal direction or a lateral direction with respect to the case body 1.

Furthermore, while the embodiment illustrates the case 10 applied to the timepiece 100, which is a wristwatch, the case 10 needs only to include a case body 1 and an exterior member 2 attached to the case body 1 and is not limited to applications to wristwatches. The devices to which the case 10 of the present invention can be applied include various timepieces, such as pocket watches that do not have a band. The case 10 of the present invention can be widely applied to, for example, electronic devices such as various smartwatches and sports watches, as well as devices that acquire biological information such as heart rate and blood flow information in addition to time.

In the above, one or more embodiments of the present invention are described. However, the scope of the present invention is not limited thereto and includes the scope of the claims below and the scope of their equivalents.

1. A case comprising:
a case body; and
an exterior member detachably attached to the case body, wherein
the case body has a notched portion formed partially in a portion that, when the exterior member is attached to the case body, faces an inner peripheral surface of the exterior member, and
the exterior member has a first inclined portion provided in a portion that, when the exterior member is attached to the case body, faces the notched portion.

2. The case according to claim 1, wherein
the case body has an extension portion that extends toward one side in a first direction and is provided along an outer periphery of the case body, the first direction being a thickness direction of the case body, and
the notched portion is formed in the extension portion.

3. The case according to claim 2, wherein the exterior member has the first inclined portion provided in the portion that faces the notched portion on the one side in the first direction.

4. The case according to claim 1, wherein a second inclined portion is provided at an edge of the notched portion of the case body.

5. The case according to claim 4, wherein the second inclined portion is provided at the edge of the notched portion on another side in a first direction, the first direction being a thickness direction of the case body.

6. The case according to claim 4, wherein the first inclined portion and the second inclined portion are inclined toward opposite sides to each other.

7. The case according to claim 4, wherein an inclination angle of the second inclined portion is larger than an inclination angle of the first inclined portion.

8. The case according to claim 7, wherein the case body is formed of a material having a higher rigidity than the exterior member.

9. The case according to claim 4, wherein, in a cross-sectional view taken at a location where the first inclined portion is provided, a portion that is provided on another side in a first direction of the first inclined portion and faces the second inclined portion of the case body is a straight portion that is not chamfered, the first direction being a thickness direction of the exterior member.

10. The case according to claim 4, wherein the exterior member has a protrusion portion at a position point-symmetrical to the first inclined portion in a plan view.

11. The case according to claim 1, wherein the exterior member has a greatest radial thickness at the first inclined portion.

12. A timepiece comprising the case according to claim 1.
